(19) United States
(12) Patent Application Publication
(10) Pub. No.: US 2024/0381063 A1
(43) Pub. Date: Nov. 14, 2024

(54) METHOD, USER EQUIPMENT, NETWORK NODE

(71) Applicant: NEC Corporation, Minato-ku, Tokyo (JP)

(72) Inventors: Maxime GRAU, Tokyo (JP); Yuhua Chen, Tokyo (JP)

(73) Assignee: NEC Corporation, Minato-ku, Tokyo (JP)

(21) Appl. No.: 18/292,497

(22) PCT Filed: Jul. 29, 2022
(86) PCT No.: PCT/JP2022/029257

§ 371 Date: Jan. 26, 2024

(30) Foreign Application Priority Data
Aug. 5, 2021 (GB) 2111338.6

(51) Int. Cl. H04W 8/00; H04W 64/00; H04W 84/06

(52) U.S. Cl. CPC H04W 8/005; H04W 64/00; H04W 84/06

(57) ABSTRACT

A communication system is disclosed that comprises a non-terrestrial network portion and a terrestrial network portion. A base station serving the non-terrestrial network portion transmits information identifying at least one group of neighbour frequencies serving a predetermined area, wherein each group comprises at least one frequency or cell of the terrestrial network. A user equipment (UE) receives the information and scans frequencies identified by the received information for finding at least one neighbour cell in any group associated with the UE. The UE may also receive information identifying a location associated with the group of neighbour frequencies or cells, in which case the UE scans only those frequencies that correspond to the location of the UE.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements relating to mobility management in the so-called ‘5G’ (or ‘Next Generation’) systems employing both a terrestrial portion and a non-terrestrial portion comprising airborne or spaceborne network nodes.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. End-user communication devices are commonly referred to as User Equipment (UE) which may be operated by a human or comprise automated devices. Such communication devices might be, for example, mobile communication devices such as mobile telephones, smartphones, smart watches, personal digital assistants, laptop/tablet computers, web browsers, e-book readers, connected vehicles, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC, IoT/Industrial IoT (IIoT) communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, NPL 1.

3GPP is also working on specifying an integrated satellite and terrestrial network (TN) infrastructure in the context of 4G and 5G. The term Non-Terrestrial Networks (NTN) refers to networks, or segments of networks, that are using an airborne or spaceborne vehicle for transmission. Satellites refer to spaceborne vehicles in Geostationary Earth Orbit (GEO) or in Non-Geostationary Earth Orbit (NGEO) such as Low Earth Orbits (LEO), Medium Earth Orbits (MEO), and Highly Elliptical Orbits (HEO). Airborne vehicles refer to High Altitude Platforms (HAPs) encompassing Unmanned Aircraft Systems (UAS)—including tethered UAS, Lighter than Air UAS and Heavier than Air UAS-all operating quasi-stationary at an altitude typically between 8 and 50 km.

NPL 2 is a study on New Radio to support such Non-Terrestrial Networks. The study includes, amongst others, NTN deployment scenarios and related system parameters (such as architecture, altitude, orbit etc.) and a description of adaptation of 3GPP channel models for Non-Terrestrial Networks (propagation conditions, mobility, etc.). NPL 3 provides further details about NTN.

Non-Terrestrial Networks are expected to:
help foster the 5G service roll out in un-served or underserved areas to upgrade the performance of terrestrial networks:
reinforce service reliability by providing service continuity for user equipment or for moving platforms (e.g. passenger vehicles-aircraft, ships, high speed trains, buses);
increase service availability everywhere: especially for critical communications, future railway/maritime/aeronautical communications; and
enable 5G network scalability through the provision of efficient multicast/broadcast resources for data delivery towards the network edges or even directly to the user equipment.

NTN access typically features the following elements (amongst others):
NTN Terminal: It may refer to a 3GPP UE or a terminal specific to the satellite system in case the satellite doesn't serve directly 3GPP UEs.
A service link which refer to the radio link between the user equipment and the space/airborne platform (which may be in addition to a radio link with a terrestrial based RAN).
A space or an airborne platform.
Gateways (‘NTN Gateways’) that connect the satellite or aerial access network to the core network. It will be appreciated that gateways will mostly likely be co-located with a base station.
Feeder links which refer to the radio links between the gateways and the space/airborne platform.

Satellite or aerial vehicles may generate several beams over a given area to provide respective NTN cells. The beams have a typically elliptic footprint on the surface of the Earth.

3GPP intends to support three types of NTN beams or cells:
Earth-fixed cells characterized by beam(s) covering the same geographical areas all the time (e.g. GEO satellites and HAPS);
quasi-Earth-fixed cells characterized by beam(s) covering one geographic area for a finite period and a different geographic area during another period (e.g. NGEO satellites generating steerable beams); and
Earth-moving cells characterized by beam(s) covering one geographic area at one instant and a different geographic area at another instant (e.g. NGEO satellites generating fixed or non-steerable beams).

With satellite or aerial vehicle keeping position fixed in terms of elevation/azimuth with respect to a given earth point e.g. GEO and UAS, the beam footprint is earth fixed.

With satellite circulating around the earth (e.g. LEO) or on an elliptical orbit around the earth (e.g. HEO) the beam footprint may be moving over the Earth with the satellite or aerial vehicle motion on its orbit. Alternatively, the beam footprint may be Earth-fixed (or quasi-Earth-fixed) temporarily, in which case an appropriate beam pointing mechanism (mechanical or electronic steering) may be used to compensate for the satellite or aerial vehicle motion.

LEO satellites may have steerable beams in which case the beams are temporarily directed to substantially fixed footprints on the Earth. In other words, the beam footprints (which represent NTN cell) are stationary on the ground for a certain amount of time before they change their focus area over to another NTN cell (due to the satellite's movement on its orbit). From cell coverage/UE point of view, this results in cell changes happening regularly at discrete intervals because different Physical Cell Identities (PCIs) and/or Synchronization Signal/Physical Broadcast Channel (PBCH) blocks (SSBs) have to be assigned after each service link change, even when these beams serve the same land area (have the same footprint). LEO satellites without steerable beams cause the beams (cells) moving on the ground constantly in a sweeping motion as the satellite moves along its orbit and as in the case of steerable beams, service link change and consequently cell changes happen regularly at discrete intervals. Similarly to service link changes, feeder link changes also happen at regular intervals due to the satellite's movement on its orbit. Both service and feeder link changes may be performed between different base stations/gateways (which may be referred to as an ‘inter-gNB radio link switch’) or within the same base station/gateway (‘intra-gNB radio link switch’).

In mobility procedures, neighbour cell information (held by each base station) plays an important roles since this information can assist the UE in its cell selection and handover between cells. Neighbour information can also be used to minimise power consumption by indicating which cells may be suitable to a UE, for example, by indicating the PCIs of any allowed/blocked cells (for intra-frequency mobility) and by indicating any frequencies the UE needs to scan (for inter-frequency mobility). In order to expedite the cell selection process, stored information for several radio access technologies, if available, may be used by the UE.

NPL 3 also discusses idle mode mobility between the terrestrial and non-terrestrial networks (or network portions), or in other words, reselection between cells operated by base stations and cells operated by satellites. This concept is referred to as TN-NTN idle mode mobility and it aims to provide service continuity and mobility mechanisms that minimise UE power consumption.

As LEO satellites are moving in predictable path, their neighbour cell list is also predictable. The neighbour cell list can be provided to UEs via broadcast system information, as is currently done in NR.

### Citation List

### Non Patent Literature

NPL 1: the ‘NGMN 5G White Paper’ V1.0, Next Generation Mobile Networks (NGMN) Alliance, <https://www.ngmn.org/5g-white-paper.html>
NPL 2: 3GPP TR 38.811 V15.4.0
NPL 3: 3GPP TR 38.821 V16.1.0
NPL 4: 3GPP TS 38.300 V16.6.0
NPL 5: 3GPP TS 37.340 V16.6.0

### Summary of Invention

### Technical Problem

However, from the point of view of the terrestrial portion of the network, there are some challenges in adapting the neighbour cell lists used by the base stations to account for NTN neighbour cells as well. In more detail, the fast (although predictable) change in neighbour cells as a satellite moves around the earth necessitates storing dynamic neighbour information. Moreover, neighbour cell relations need to be scaled to cover very large areas when NTN cells are included as well. For example, in case of LEO satellites, the beam footprint may be 100 km or more, much greater than most terrestrial network cells (since 1 km is considered a macro cell), and in case of GEO cells the beam footprint may be as big as 3500 km.

Generally, neighbouring NTN cells will have comparable cell radii and the number of these neighbours should be similar to the legacy TN/TN scenario. However, due to their smaller size, there will be many more TN neighbouring cells for an NTN cell, which includes traditional neighbouring TN cells at the NTN cell edge as well as TN cells inside the NTN cell coverage (as illustrated in FIG. 5).

A problem associated with serving a UE via an NTN cell is that (in case the NTN cell has many TN neighbours) there is no small set of neighbouring cells that can effectively expedite the cell selection process of every UE within its coverage (of hundreds of kms) which can result in increased power consumption and significant delays for finding a suitable cell for the UEs. The NTN cell will have to either: i) provide all available neighbouring frequencies even though most of them will not be relevant for each given UE (Heavy DL signalling overhead and poor UE EE): or ii) not provide any specific neighbouring frequencies to scan leading to UEs scanning all possible frequencies (No DL signalling overhead and very poor UE EE). Additionally, a UE in a deserted area with no TN coverage will not be aware that no TN neighbour cell is available and will scan every possible frequency repeatedly without finding any suitable cell in that area.

Accordingly, the present disclosure seeks to provide methods and associated apparatus that address or at least alleviate (at least some of) the above described issues.

### Solution to Problem

In one aspect, the disclosure provides a method performed by a user equipment (UE) for mobility between cells of a non-terrestrial network and a terrestrial network, the method comprising: receiving information identifying at least one group of neighbour frequencies serving a predetermined area, wherein each group comprises at least one frequency or cell of the terrestrial network; and scanning frequencies identified by the received information for finding at least one neighbour cell in any group associated with the UE.

In one aspect, the disclosure provides a method performed by a user equipment (UE) for mobility between cells of a non-terrestrial network and a terrestrial network, the method comprising: receiving i) information identifying a predetermined area and any neighbour frequency serving that predetermined area via at least one cell of the terrestrial network: determining a current location of the UE; and depending on the current location of the UE and the received information, scanning frequencies serving that predetermined area for finding at least one neighbour cell.

In one aspect, the disclosure provides a method performed by a network node for assisting mobility of a user equipment (UE) between cells of a non-terrestrial network and a terrestrial network, the method comprising: transmitting information identifying at least one group of neighbour frequencies serving a predetermined area, wherein each group comprises at least one frequency or cell of the terrestrial network, the information being adapted for use by the UE in scanning frequencies for finding at least one neighbour cell in any group associated with the UE.

In one aspect, the disclosure provides a method performed by a network node for assisting mobility of a user equipment (UE) between cells of a non-terrestrial network and a terrestrial network, the method comprising: transmitting information identifying a predetermined area and any neighbour frequency serving that predetermined area via at least one cell of the terrestrial network, the information being adapted for use by the UE, depending on a current location of the UE, in scanning frequencies serving that predetermined area for finding at least one neighbour cell.

In one aspect, the disclosure provides a user equipment (UE) configured to perform mobility between cells of a non-terrestrial network and a terrestrial network, the UE comprising: means (e.g. a memory storing instructions, a processor, and a transceiver) for receiving information identifying at least one group of neighbour frequencies serving a predetermined area, wherein each group comprises at least one frequency or cell of the terrestrial network; and means (e.g. a memory storing instructions, a processor, and a transceiver) for scanning frequencies identified by the received information for finding at least one neighbour cell in any group associated with the UE.

In one aspect, the disclosure provides a user equipment (UE) configured to perform mobility between cells of a non-terrestrial network and a terrestrial network, the UE comprising: means (e.g. a memory storing instructions, a processor, and a transceiver) for receiving information identifying a predetermined area and any neighbour frequency serving that predetermined area via at least one cell of the terrestrial network: means (e.g. a memory storing instructions, and a processor) for determining a current location of the UE; and means (e.g. a memory storing instructions, a processor, and a transceiver) for scanning, depending on the current location of the UE and the received information, frequencies serving that predetermined area for finding at least one neighbour cell.

In one aspect, the disclosure provides a network node for assisting mobility of a user equipment (UE) between cells of a non-terrestrial network and a terrestrial network, the network node comprising means (e.g. a memory storing instructions, a processor, and a transceiver) for transmitting information identifying at least one group of neighbour frequencies serving a predetermined area, wherein each group comprises at least one frequency or cell of the terrestrial network, the information being adapted for use by the UE in scanning frequencies for finding at least one neighbour cell in any group associated with the UE.

In one aspect, the disclosure provides a network node for assisting mobility of a user equipment (UE) between cells of a non-terrestrial network and a terrestrial network, the network node comprising means (e.g. a memory storing instructions, a processor, and a transceiver) for transmitting information identifying a predetermined area and any neighbour frequency serving that predetermined area via at least one cell of the terrestrial network, the information being adapted for use by the UE, depending on a current location of the UE, in scanning frequencies serving that predetermined area for finding at least one neighbour cell.

Although for efficiency of understanding for those of skill in the art, the disclosure will be described in detail in the context of a 3GPP system (5G networks including NTN), the principles of the disclosure can be applied to other systems as well.

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Embodiments of the disclosure will now be described, by way of example, with reference to the accompanying drawings in which:

FIG. 1 illustrates schematically a mobile (cellular or wireless) telecommunication system to which embodiments of the disclosure may be applied;

FIG. 2 is a schematic block diagram of a mobile device forming part of the system shown in FIG. 1:

FIG. 3 is a schematic block diagram of an NTN node (e.g. satellite/UAS platform) forming part of the system shown in FIG. 1:

FIG. 4 is a schematic block diagram of an access network node (e.g. base station) forming part of the system shown in FIG. 1:

FIG. 5 illustrates schematically an exemplary scenario in which the present disclosure may be applied:

FIG. 6 illustrates schematically an exemplary scenario in which the present disclosure may be applied; and

FIG. 7 illustrates schematically some exemplary architecture options for the provision of NTN features in the system shown in FIG. 1.

### DESCRIPTION OF EMBODIMENTS

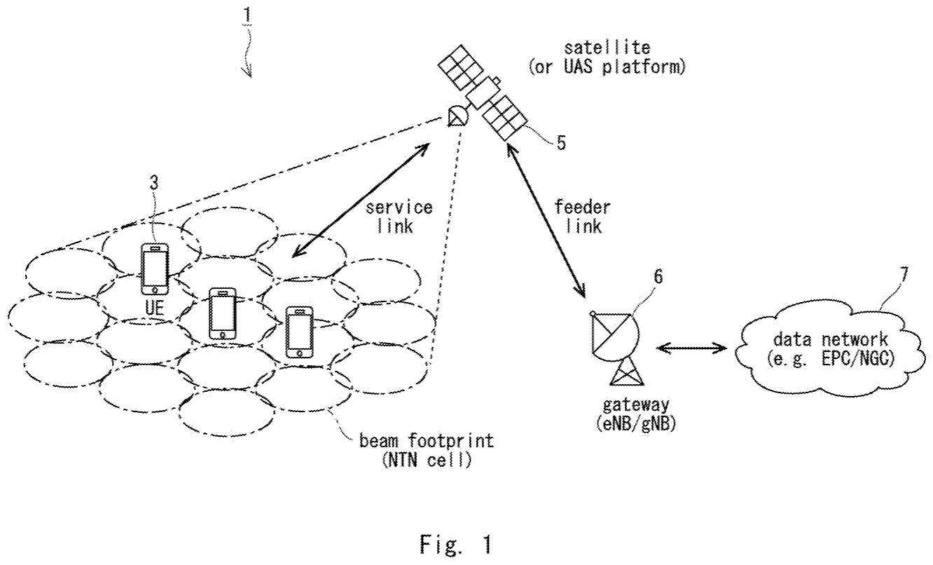

Overview FIG. 1 illustrates schematically a mobile (cellular or wireless) telecommunication system 1 to which embodiments of the disclosure may be applied.

In this system 1, users of mobile devices 3 (UEs) can communicate with each other and other users via access network nodes respective satellites 5 and/or base stations 6 and a data network 7 using an appropriate 3GPP radio access technology (RAT), for example, an Evolved Universal Terrestrial Radio Access (E-UTRA) and/or 5G RAT. As those skilled in the art will appreciate, whilst three mobile devices 3, one satellite 5, and one base station 6 are shown in FIG. 1 for illustration purposes, the system, when implemented, will typically include other satellites/UAS platforms, base stations/RAN nodes, and mobile devices (UEs).

It will be appreciated that a number of base stations 6 form a (radio) access network or (R)AN, and a number of NTN nodes 5 (satellites and/or UAS platforms) form a Non-Terrestrial Network (NTN). Each NTN node 5 is connected to an appropriate gateway (in this case co-located with a base station 6) using a so-called feeder link and connected to respective UEs 3 via corresponding service links. Thus, when served by an NTN node 5, a mobile device 3 communicates data to and from a base station 6 via the NTN node 5, using an appropriate service link (between the mobile device 3 and the NTN node 5) and a feeder link (between the NTN node 5 and the gateway/base station 6). In other words, the NTN forms part of the (R)AN, although it may also provide satellite communication services independently of E-UTRA (or ‘4G’) and/or New Radio (or ‘5G’) communication services.

Although not shown in FIG. 1, neighbouring base stations 6 are connected to each other via an appropriate base station to base station interface (such as the so-called ‘X2’ interface, ‘Xn’ interface and/or the like). The base station 6 is also connected to the data network nodes via an appropriate interface (such as the so-called ‘S1’, ‘NG-C’, ‘NG-U’ interface, and/or the like).

The data (or core) network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the data network 7 of a ‘Next Generation’/5G system will include user plane entities and control plane entities, such as one or more control plane functions (CPFs) and one or more user plane functions (UPFs). The so-called Access and Mobility Management Function (AMF) in 5G, or the Mobility Management Entity (MME) in 4G, is responsible for handling connection and mobility management tasks for the mobile devices 3. The data network 7 is also coupled to other data networks such as the Internet or similar Internet Protocol (IP) based networks (not shown in FIG. 1).

Each NTN node 5 controls a number of directional beams via which associated NTN cells may be provided. Specifically, each beam has an associated footprint on the surface of the Earth which corresponds to an NTN cell. Each NTN cell (beam) has an associated Physical Cell Identity (PCI) and/or beam identity and a frequency (also referred to as ‘carrier frequency’). The beam footprints may be moving as the NTN node 5 is travelling along its orbit. Alternatively, the beam footprint may be earth fixed, in which case an appropriate beam pointing mechanism (mechanical or electronic steering) may be used to compensate for the movement of the NTN node 5.

Each cell has an associated ‘NR Cell Global Identifier’ (NCGI) to identify the cell globally. The NCGI is constructed from the Public Land Mobile Network (PLMN) identity (PLMN ID) the cell belongs to and the NR Cell Identity (NCI) of the cell. The PLMN ID included in the NCGI is the first PLMN ID within the set of PLMN IDs associated to the NR Cell Identity in System Information Block Type 1 (SIB1). The ‘gNB Identifier’ (gNB ID) is used to identify a particular gNB within a PLMN. The gNB ID is contained within the NCI of its cells. The ‘Global gNB ID’ is used to identify a gNB globally and it is constructed from the PLMN identity the gNB belongs to and the gNB ID. The Mobile Country Code (MCC) and Mobile Network Code (MNC) are the same as included in the NCGI.

A UE 3 that is served via the terrestrial network portion can receive and transmit data via a TN cell (base station 6), and a UE 3 served via the non-terrestrial network portion can receive and transmit data via an NTN cell, using one of the beams of the NTN node 5 (satellite). When the UE 3 initially establishes an RRC connection with a base station 6 (via a TN cell or an NTN cell) the UE 3 also registers with an appropriate AMF 9 (or MME). The UE 3 is in the so-called RRC connected state and an associated UE context is maintained by the network.

Over time, due to movement of the UE 3 and/or movement of the serving NTN node 5, the UE 3 moves between cells (and/or from beam to beam) using appropriate mobility procedures. In order to do so, the base station 6 provides the UE 3 appropriate configuration data and/or assistance information based on which the UE 3 can determine which cell/beam to use (for communication or camping) and which neighbour cells are available for the UE 3 as potential target cells. A neighbour cell can be identified based on its associated PCI and/or frequency.

For assisting UE handover and cell reselection, each base station 6 maintains an associated neighbour cell relation table (or database) for each cell managed by that base station 6. The neighbour cell relation table lists all known neighbour cells for a given cell (although this information may be updated using well known mechanisms which will not be described here). In this system, the neighbour cells may comprise TN cells and NTN cells.

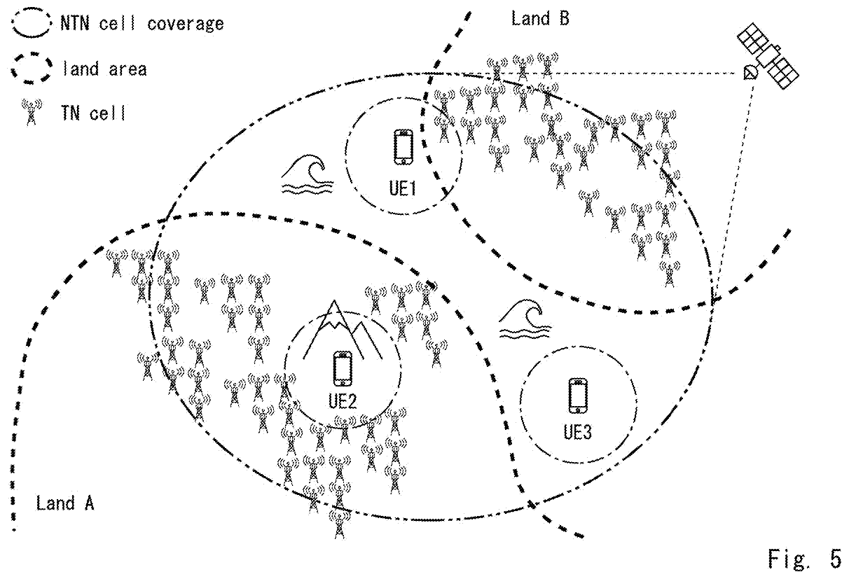

FIG. 5 illustrates schematically an exemplary distribution of TN cells over two land areas (denoted ‘Land A’ and ‘Land B’) separated by a body of water, and an NTN cell that provides partial coverage to both land areas and provides some coverage outside the land areas as well. As can be seen, in this case each TN cell will have a relatively small number of neighbour cells (i.e. the TN cells surrounding the cell and one NTN cell). However, the NTN cell will have a relatively large number of neighbours as the coverage of the NTN cell overlaps with many TN cells in both land areas A and B. The NTN cell may also have a number of other NTN cells as neighbours, which are not shown in FIG. 5. Although an NTN cell can provide robust coverage, it will be appreciated that UEs 3 will want to connect to a smaller cell (here TN cell) whenever in proximity.

FIG. 5 also shows three NTN/TN mobility scenarios, using the examples of the mobile devices denoted ‘UE1’ to ‘UE3’. In these scenarios, due to the size of the satellite cell footprint (NTN cell), most neighbouring cells of the NTN cell are irrelevant to a given UE.

For example, UE1 is travelling through a zone without TN cell coverage (e.g. at sea) and it would only be interested in the few cells on the shore of Land B. UE2 is located in a geographically limited area with low coverage (e.g. mountains) and may only be in the proximity of a few towns in Land A and may get in line-of-sight of some TN cells serving these towns. UE3 is between the two land areas and there are no TN cells in proximity for this UE 3, not even in line-of-sight. Thus, UE3 is currently in an NTN only area (effectively without any suitable neighbour cells).

In order to avoid each UE 3 having to scan all available neighbouring frequencies (or all possible frequencies) including those that are not relevant to that particular UE 3, the nodes of this network are configured to group frequencies/cells that serve a common area and configure the UEs 3 to limit their cell search to one or more specific group of frequencies (i.e. cells associated with those frequencies). By having different groups of TN cells in specific geographic areas across the coverage of the NTN cell, the UEs 3 can limit the amount of time and energy spent scanning for neighbours, since the UEs 3 can restrict their scanning to the frequencies used by the TN cells in their configured group(s). In any case, each UE 3 is likely to be out of coverage from most other neighbouring TN cells located in any other group.

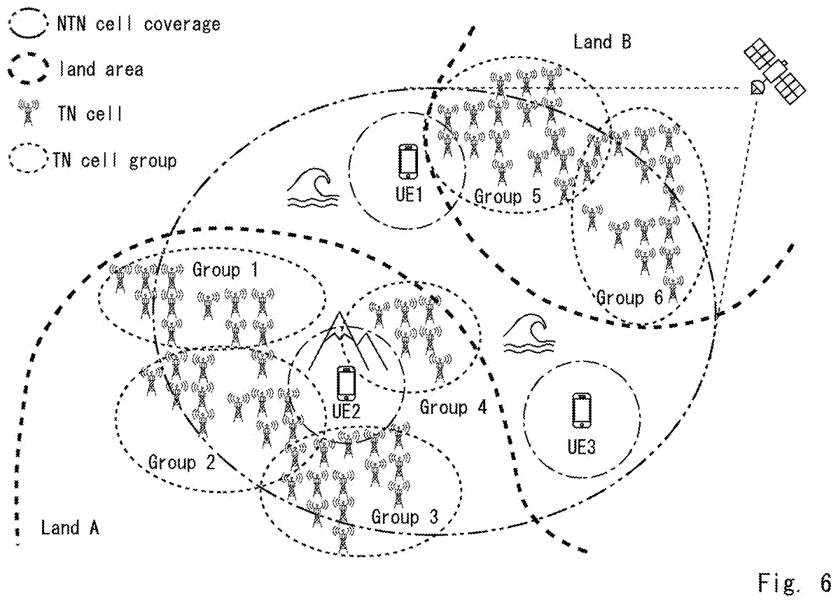

A possible grouping of cells is shown in FIG. 6. As can be seen, there are four cell groups over Land A (groups 1 to 4) and there are a further two groups of cells over Land B (groups 5 and 6). The grouping of cells may be recorded in the neighbour cell relation table for the NTN cell which may be maintained by the associated gateway/base station 6 (not shown in FIG. 6).

The cell grouping may be realised using one of the following options (or a combination of the options):
Option 1: Simple blind grouping, in which case the frequencies of neighbouring cells that form a group are signalled to the UEs 3, with no specific order or common property. In this case, the base station 6 (NTN node 5) are configured to broadcast (which may be on demand) information identifying all the cells or frequencies, group by group. In other words, rather than simply broadcasting information identifying all its neighbour cells/frequencies, each base station 6 (NTN node 5) is configured to broadcast information identifying the groups that their neighbour cells/frequencies belong to (if any). The grouping may be indicated using one or more appropriately formatted information element (e.g. a list of cells/frequencies per neighbour group). It will be appreciated that the base station 6 (NTN node 5) does not need to indicate any specific group to a particular UE 3. As soon as a UE 3 successfully finds a cell in a given frequency, it can see which group this cell/frequency belongs to and it can scan for other cells/frequencies in this group. On the other hand, if the base station 6 (NTN node 5) does indicate to a UE 3 which group(s) to use, then the UE 3 will scan the frequencies/cells in its configured group(s). Accordingly, the UE 3 can be configured to scan a subset of all neighbour cells/frequencies of its serving cell (e.g. NTN cell), and this subset can be indicated to the UE 3 by identifying the grouping of cells.
Option 2: Grouping with an associated location, in which case neighbour cells (frequencies) are grouped based on their associated location (e.g. within a predefined zone). In this case, the base station 6 (NTN node 5) is configured to group frequencies as in Option 1 but also including information identifying a location (or an area) associated with each group. Thus, in addition to broadcasting information identifying all the cells or frequencies per group, the base station 6 (NTN node 5) is configured to transmit to the UEs information relating to the location of each group (e.g. using one or more appropriately formatted information element). Assuming that the UE 3 knows its position, it can choose one or more group(s) of frequencies/cells based on the location information obtained from the base station 6/NTN node 5. In this case, the UE 3 can also determine that it does not need to scan any cells/frequencies when the UE 3 is located in an area/zone with no TN cells (i.e. when there are no groups assigned to that area/zone).

Beneficially, using the above approach, the NTN cell can indicate the appropriate neighbouring frequencies to each UE without unnecessary downlink signalling overhead and without wasting UEs resources for scanning those frequencies/cells that are not relevant to that UE. In case of Option 2, a UE in a deserted area with no TN coverage does not need to scan every possible frequency repeatedly since it can determine that there are no suitable cells in that area.

### User Equipment (UE)

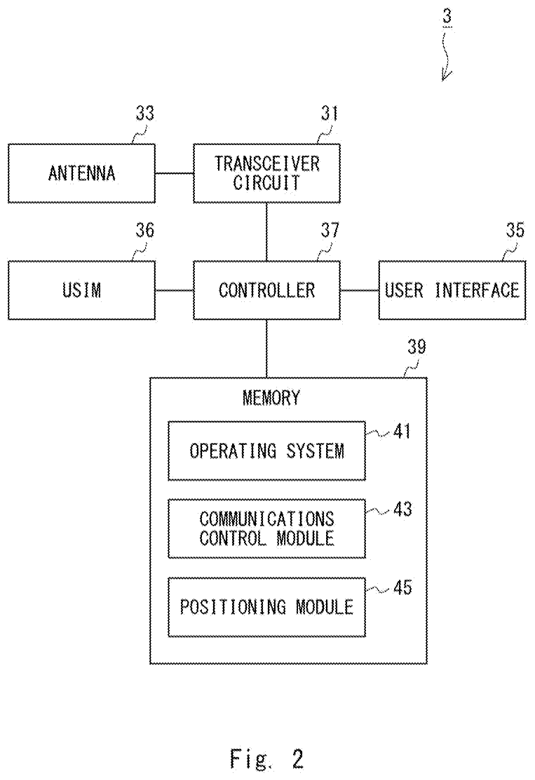

FIG. 2 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 2, the UE 3 will of course have all the usual functionality of a conventional mobile device (such as a user interface 35 and a Universal Subscriber Identity Module (USIM) 36) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and a positioning module 45 (which is optional in some UEs).

The communications control module 43 is responsible for handling (generating/sending/receiving) signalling messages and uplink/downlink data packets between the UE 3 and other nodes, including NTN nodes 5, (R)AN nodes 6, and core network nodes. Although not shown in FIG. 2, the communications control module 43 has appropriate sub-modules for the PHY, MAC, and RRC layers, amongst others. The signalling may comprise control signalling (such as broadcast signalling/RRC signalling) related to cell grouping and provision of associated assistance information.

If present, the positioning module 45 is responsible for determining the position of the UE 3, for example based on Global Navigation Satellite System (GNSS) signals.

### NTN Node (Satellite/UAS Platform)

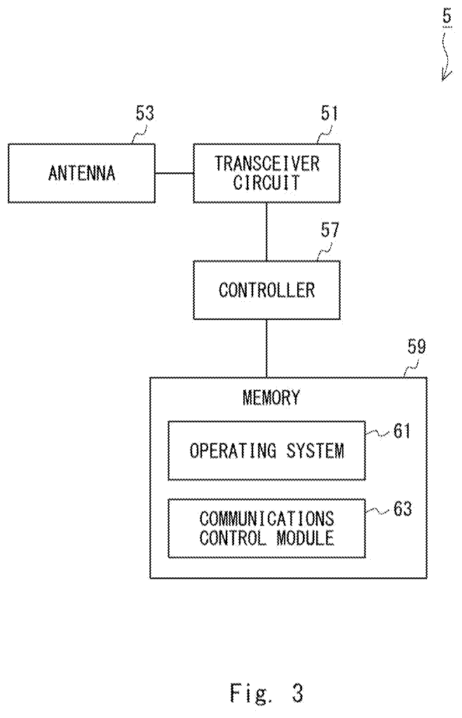

FIG. 3 is a block diagram illustrating the main components of the NTN node 5 (a satellite or a UAS platform) shown in FIG. 1. As shown, the NTN node 5 includes a transceiver circuit 51 which is operable to transmit signals to and to receive signals from connected UE(s) 3 via one or more antenna 53 and to transmit signals to and to receive signals from other network nodes such as gateways and base stations (either directly or indirectly). A controller 57 controls the operation of the NTN node 5 in accordance with software stored in a memory 59. The software may be pre-installed in the memory 59 and/or may be downloaded via the telecommunication network 1 or from a removable data storage device (RMD), for example. The software includes, among other things, an operating system 61, and a communications control module 63.

The communications control module 63 is responsible for handling (generating/sending/receiving/relaying) signalling between the NTN node 5 and other nodes, such as the UE 3, base stations 6, gateways, and core network nodes (via the base stations/gateways). The signalling may comprise control signalling (such as broadcast signalling/RRC signalling) related to cell grouping and provision of associated assistance information.

### Base Station/Gateway (Access Network Node)

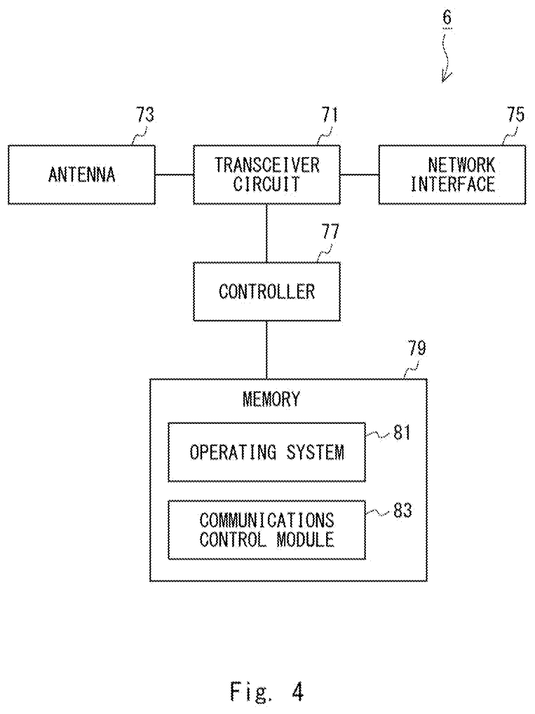

FIG. 4 is a block diagram illustrating the main components of the gateway 6 shown in FIG. 1 (a base station (gNB) or a similar access network node). As shown, the gateway/gNB 6 includes a transceiver circuit 71 which is operable to transmit signals to and to receive signals from connected UE(s) 3 via one or more antenna 73 and to transmit signals to and to receive signals from other network nodes (either directly or indirectly) via a network interface 75. Signals may be transmitted to and received from the UE(s) 3 either directly and/or via the NTN node 5, as appropriate. The network interface 75 typically includes an appropriate base station-base station interface (such as X2/Xn) and an appropriate base station-core network interface (such as S1/NG-C/NG-U). A controller 77 controls the operation of the base station 6 in accordance with software stored in a memory 79. The software may be pre-installed in the memory 79 and/or may be downloaded via the telecommunication network 1 or from a removable data storage device (RMD), for example. The software includes, among other things, an operating system 81, and a communications control module 83.

The communications control module 83 is responsible for handling (generating/sending/receiving) signalling between the base station 6 and other nodes, such as the UE 3, NTN nodes 5, and core network nodes. Although not shown in FIG. 4, the communications control module 83 has appropriate sub-modules for the PHY, MAC, and RRC layers, amongst others. The signalling may comprise control signalling (such as broadcast signalling/RRC signalling) related to cell grouping and provision of associated assistance information.

### DETAILED DESCRIPTION

The following is a description of an exemplary procedure performed by the nodes of the system shown in FIG. 1, with reference to the exemplary scenario shown in FIG. 6.

The goal for the network is to find a balance between multiple objectives such as reducing the number of cells in a group, reducing the number of groups where a UE can find suitable cells, and limiting the overall number of groups. However, it will be appreciated that groups can be of any size and they can overlap (see e.g. groups 5 and 6), which may be up to network implementation.

In one option (Option 1) cell grouping is realised by a simple ‘blind’ grouping, in which case the frequencies of neighbouring cells that form a group do not need to have a specific order or common property. The groups applicable for the neighbours of a given cell (NTN cell in particular) are signalled to the UEs 3, in this example using broadcast signalling (which may be on demand). Specifically, the base station 6 (via the NTN node 5) is configured to broadcast (using their respective communication control modules 63/83) information identifying all the cells or frequencies, group by group. In this example, the grouping is indicated using one or more appropriately formatted information element (e.g. a list of cells/frequencies per neighbour group).

For instance, certain frequencies that are mostly used in a given country (or a subset of such frequencies) may be grouped together so that UEs 3 in that country do not need to scan for all the various frequencies used in all the countries potentially covered by the NTN cell. However, a UE 3 cannot know if it has candidate neighbouring cells located in different groups since the grouping is blind. Accordingly, the base station 6 (NTN node 5) does not need to indicate any specific group to a particular UE 3. As soon as a UE 3 successfully finds a cell in a given frequency, it can see which group this cell/frequency belongs to and the UE 3 can scan for other cells/frequencies in this group (i.e. only those frequencies that are used in the country where the UE 3 is located, using the previous example). On the other hand, if the base station 6 (NTN node 5) does indicate to a UE 3 which group(s) to use, for example using dedicated signalling at RRC connection setup, then the UE 3 will scan the frequencies/cells in its configured group(s). Accordingly, the UE 3 can be configured, either implicitly or explicitly, to scan a subset of all neighbour cells/frequencies of its serving cell (e.g. NTN cell), and this subset can be indicated to the UE 3 by identifying the grouping of cells.

In order to realise cell grouping, without significant changes to current specifications, the grouping of cells may be indicated via the inter FreqCarrierFreqList information element (IE). For example, the interFreqCarrierFreqList IE may be included in an appropriate system information block (SIB), such as SIB type 4 (SIB4), as shown below. A cell may be identified based on its associated PCI or frequency (or both). SIB4 identifies each neighbour cell by its frequency and, optionally, by its PCI. In this case, the interFreqCarrierFreqList IE includes all frequencies used by neighbour cells and a list of pointers for each associated group (per frequency) is indicated using an optional IE (e.g. interFreqCarrierFreqListGroups IE).

| | |
|---|---|
| SIB4 ::= | SEQUENCE { |

| interFreqCarrierFreqList | InterFreqCarrierFreqList, | |
|---|---|---|
| lateNonCriticalExtension | OCTET STRING | OPTIONAL, |

```
  ...,
  [[
  interFreqCarrierFreqList-v1610
```

| | |
|---|---|
| InterFreqCarrierFreqList-v1610 | OPTIONAL -- Need R |

```
  ]]
  interFreqCarrierFreqListGroups
```

| | |
|---|---|
| InterFreqCarrierFreqListGroups, | OPTIONAL, |

}
InterFreqCarrierFreqList ::=

SEQUENCE (SIZE (1..maxFreq)) OF InterFreqCarrierFreqInfo

InterFreqCarrierFreqListGroups ::=

SEQUENCE (SIZE (1..maxGroup)) OF INTEGER (1..maxFreq)

In a modification of this option, the interFreqCarrierFreqList IE includes the information of the first group and any additional groups (information elements related to the groups) are added in the form of a sequence of interFreqCarrierFreqList IEs. This approach allows using less signalling in case one or more frequency groups overlap, and may be implemented as follows.

| | |
|---|---|
| SIB4 ::= | SEQUENCE { |

| interFreqCarrierFreqList | InterFreqCarrierFreqList, | |
|---|---|---|
| lateNonCriticalExtension | OCTET STRING | OPTIONAL, |

```
  ...,
  [[
  interFreqCarrierFreqList-v1610
```

| | |
|---|---|
| InterFreqCarrierFreqList-v1610 | OPTIONAL -- Need R |

```
  ]]
  interFreqCarrierFreqListGroups
```

| | |
|---|---|
| InterFreqCarrierFreqListGroups, | OPTIONAL, |

}
InterFreqCarrierFreqListGroups ::=

SEQUENCE (SIZE (0..maxGroup-1)) OF InterFreqCarrierFreqList

It will be appreciated that in case of NTN cells, UEs 3 will be aware that their serving cell type is NTN before reading SIB4. Thus, the UEs 3 can adapt their behaviour and understand that the (legacy) interFreqCarrierFreqList IE only refers to the first group. Accordingly, cell grouping can be indicated in the SIB4 without compromising backwards compatibility.

In another option (Option 2), cell grouping is realised by grouping neighbour cells (frequencies) based on their associated location (e.g. within a predefined zone). In other words, the frequencies/cells in a given group may have a common property relating to their location (e.g. in the same country or a part of a country). The location may be the physical location of the cell (e.g. cell centre or transceiver location) or a location/area served by that cell.

In this case, the base station 6 (NTN node 5) is configured to group frequencies by including information identifying a location (or an area) associated with each group. Thus, in addition to broadcasting information identifying all the cells or frequencies per group, the base station 6 (NTN node 5) is configured to transmit to the UEs information relating to the location of each group (e.g. using one or more appropriately formatted information element).

The number of groups and the specific cell grouping is up to network implementation, but if a UE 3 has a potential neighbour located in multiple groups, the UE 3 can easily know which frequencies to scan based on the information relating to the location of each group.

It will be appreciated that the information regarding the group location may be provided in any suitable way to allow UEs to determine where the neighbour cell groups are located or which areas they serve. For example, information relating to the location associated with a group may be provided as one or more of the following: coordinates inside the cell group (e.g. centre of the zone, barycentre of cells); centre of a cell group with radius; and a zone defined by a set of coordinates (e.g. a polygon).

In this case, the interFreqCarrierFreqList IE may be included in SIB4, together with one or more information elements indicating the location associated with a given group, as shown below. In this example, the following location specific IEs are used: Groups With Location, groupLocationInfo, and groupPointers. However, any other suitable information element may be used.

| | |
|---|---|
| SIB4 ::= | SEQUENCE { |

| interFreqCarrierFreqList | InterFreqCarrierFreqList, | |
|---|---|---|
| lateNonCriticalExtension | OCTET STRING | OPTIONAL, |

```
  ...,
  [[
  interFreqCarrierFreqList-v1610
```

| | |
|---|---|
| InterFregCarrierFreqList-v1610 | OPTIONAL -- Need R |

```
  ]]
  interFreqCarrierFreqListGroups
```

| | |
|---|---|
| InterFreqCarrierFreqListGroups, | OPTIONAL, |

}
InterFreqCarrierFreqList ::=

SEQUENCE (SIZE (1..maxFreq)) OF InterFreqCarrierFreqInfo

InterFreqCarrierFreqListGroups ::=

SEQUENCE (SIZE (1..maxGroup)) OF GroupsWithLocation

| | |
|---|---|
| GroupsWithLocation ::= | SEQUENCE { |
| groupLocationInfo | GroupLocationInfo |
| groupPointers | SEQUENCE (SIZE (1..maxFreq)) OF |

INTEGER (1..maxFreq)
}

Assuming that the UE 3 knows its position (using its positioning module 45), it can choose one or more group(s) of frequencies/cells based on the location information obtained from the base station 6/NTN node 5. In this case, the UE 3 can also determine that it does not need to scan any cells/frequencies when the UE 3 is located in an area/zone with no TN cells (i.e. when there are no groups assigned to that area/zone).

In summary, the neighbouring frequencies may be organised into groups such as:
Group 1
   Frequency 1: optional {cell list}
   Frequency 2: optional {cell list}
   Frequency 5: optional {cell list}
   . . .
   Optionally: location information
Group 2:
   Frequency 1: optional {cell list}
   Frequency 3: optional {cell list}
   Frequency 4: optional {cell list}
   . . .
   Optionally: location information
   . . .

In a special case, when there are no neighbouring cells for a given location, SIB4 may include the following information (for that location):
No neighbouring frequency
location information

A UE at a given location only needs to scan one or only a few group(s) relevant to its location but not all groups.

In case of Option 1 (when location information is not provided), the UE needs to guess which group is relevant to its location, e.g. by scanning all groups briefly, until it finds a neighbour cell/frequency in one group, then this group is determined to be the relevant neighbour group for the UE's currently location (i.e. the UE may ignore any other groups unless they share at least one frequency in which case the UE may need to perform additional scanning).

In case of Option 2 (when location information is provided), the UE needs to match its own location to the location information in SIB4 and decide which group/groups is/are relevant and need to be scanned for cell selection/reselection.

The special case without any neighbouring frequency for a given location may be referred to as Option 3. In this case the SIB4 may indicate appropriate location information either implicitly (e.g. any location not associated with any group does not have neighbours) or using a blank frequency group with location information.

### Modifications and Alternatives

Detailed embodiments have been described above. As those skilled in the art will appreciate, a number of modifications and alternatives can be made to the above embodiments whilst still benefiting from the disclosures embodied therein. By way of illustration only a number of these alternatives and modifications will now be described.

In the above description NTN and TN cells are used as examples. However, the broad coverage of the NTN cell compared to the TN cells is similar to the coverage of a macro cell to small cells within its coverage. Thus, it will be appreciated that the above described embodiments may be applied to other types of cells as well, such as macro cells and small cells (home base stations and/or the like).

Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). NPL 4 and NPL 5 define the following nodes, amongst others:
gNB: node providing NR user plane and control plane protocol terminations towards the UE, and connected via the NG interface to the 5G core network (5GC).
ng-eNB: node providing E-UTRA user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).
NG-RAN node: either a gNB or an ng-eNB.

It will be appreciated that the above embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

TABLE 1
types of satellites and UAS platforms

| | | | | Typical beam | |
|---|---|---|---|---|---|
| Platforms | Altitude range | | Orbit | footprint size | |
| Low-Earth Orbit | 300-1500 | km | Circular around the | 100-1000 | km |
| (LEO) satellite | | | earth | | |
| Medium-Earth Orbit | 7000-25000 | km | | 100-1000 | km |
| (MEO) satellite | | | | | |
| Geostationary Earth | 35 786 | km | Notional station keeping | 200-3500 | km |
| Orbit (GEO) satellite | | | position fixed in terms | | |
| UAS platform | 8-50 km | | of elevation/azimuth | 5-200 | km |
| (including HAPS) | (20 km for HAPS) | | with respect to a given | | |
| | | | earth point | | |
| High Elliptical Orbit | 400-50000 | km | Elliptical around the | 200-3500 | km |

| | |
|---|---|
| (HEO) satellite | earth |

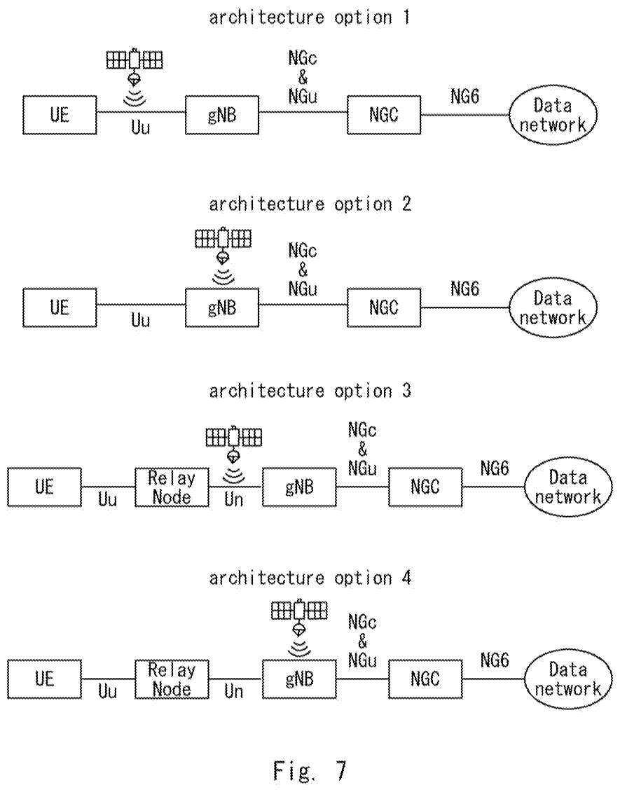

It will be appreciated that there are various architecture options to implement NTN in a 5G system, some of which are illustrated schematically in FIG. 7. The first option shown is an NTN featuring an access network serving UEs and based on a satellite/aerial vehicle with bent pipe payload and gNB on the ground (satellite hub or gateway level). The second option is an NTN featuring an access network serving UEs and based on a satellite/aerial vehicle with gNB on board. The third option is an NTN featuring an access network serving Relay Nodes and based on a satellite/aerial vehicle with bent pipe payload. The fourth option is an NTN featuring an access network serving Relay Nodes and based on a satellite/aerial vehicle with gNB. It will be appreciated that other architecture options may also be used, for example, a combination of two or more of the above described options. Alternatively, the relay node may comprise a satellite/UAS. It will be appreciated that similar architecture options may be used in 4G/LTE systems as well, but with an eNB instead of the gNB, an EPC instead of NGC, and using the appropriate LTE interfaces instead of the NG interfaces shown in FIG. 7.

In the above description, the UE, the NTN node (satellite/UAS platform), and the access network node (base station) are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors: microprocessors: central processing units (CPUs); arithmetic logic units (ALUs): input/output (IO) circuits; internal memories/caches (program and/or data): processing registers: communication buses (e.g. control, data and/or address buses): direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the NTN node, and the access network node (base station) as a signal over a computer network, or on a recording medium. Further, the functionality performed by part or all of this software may be performed using one or more dedicated hardware circuits. However, the use of software modules is preferred as it facilitates the updating of the UE, the NTN node, and the access network node (base station) in order to update their functionalities.

The above embodiments are also applicable to ‘non-mobile’ or generally stationary user equipment. The above described mobile device may comprise an MTC/IoT device and/or the like.

The method performed by the UE may further comprise: receiving (from the network node) information identifying a location associated with the group of neighbour frequencies or cells; and scanning frequencies identified by the received information, based on a location of the UE and said information identifying a location associated with the group, for finding at least one neighbour cell.

The method performed by the UE may comprise: receiving (from the network node) information identifying a plurality of groups of neighbour frequencies serving respective predetermined areas: performing a search for finding at least one potential neighbour cell; and determining a group associated with the UE, based on a frequency used by the at least one potential neighbour cell and the information identifying the plurality of groups of neighbour frequencies, for finding at least one neighbour cell in the group to which the at least one potential neighbour cell belongs.

The network node may transmit to the UE the information identifying the at least one group of neighbour frequencies or said plurality of groups of neighbour frequencies in an information element of a system information block (e.g. system information block type 4). The network node may transmit to the UE the information identifying a predetermined area in an information element of a system information block (e.g. system information block type 4). The network node may transmit to the UE the information identifying any neighbour frequency in an information element of a system information block (e.g. system information block type 4).

The method performed by the UE may comprise: receiving information identifying a plurality of predetermined areas and any associated neighbour frequency: performing a search for finding at least one potential neighbour cell; and scanning frequencies serving each predetermined area that corresponds to the current location of the UE. The method performed by the network node may comprise transmitting the information identifying a plurality of predetermined areas and any associated neighbour frequency.

The UE may be configured not to scan any frequency that is not associated with at least one predetermined area that corresponds to the current location of the UE.

Various other modifications will be apparent to those skilled in the art and will not be described in further detail here.

The whole or part of the exemplary embodiments disclosed above can be described as, but not limited to, the following supplementary notes.

### Supplementary Note 1

A method performed by a user equipment (UE) for mobility between cells of a non-terrestrial network and a terrestrial network, the method comprising: receiving first information identifying at least one group of neighbour frequencies, wherein each group of the at least one group corresponds to at least one frequency or cell of the terrestrial network; and scanning frequencies identified by the first information for finding at least one neighbour cell in one group from the at least one group indicated by the first information.

### Supplementary Note 2

The method according to Supplementary Note 1, further comprising:
receiving second information identifying a location associated with the each group of the at least one group; and
scanning frequencies identified by the first information, based on a location of the UE and the second information.

### Supplementary Note 3

The method according to Supplementary Note 1, further comprising:
performing a search for finding at least one potential neighbour cell for each group of the at least one group; and
determining the one group, based on a frequency used by the at least one potential neighbour cell and the first information.

### Supplementary Note 4

The method according to Supplementary Note 1, wherein
the each group includes a respective predetermined area where the neighbour frequencies corresponding to the each group serves, and the method further comprises:
determining a current location of the UE, and wherein
the scanning includes scanning the frequencies identified by the first information, serving that the respective predetermined area corresponding to the current location of the UE for finding the at least one neighbour cell.

### Supplementary Note 5

The method according to any one of Supplementary Notes 1 to 4, wherein the first information is transmitted via an information element of a system information block.

### Supplementary Note 6

The method according to Supplementary Note 4 or 5, further comprising:
performing a search for finding at least one potential neighbour cell for each predetermined area; and
scanning frequencies serving the each predetermined area that corresponds to the current location of the UE.

### Supplementary Note 7

The method according to any one of Supplementary Notes 4 to 6, further comprising not scanning any frequency that is not associated with at least one predetermined area that corresponds to the current location of the UE.

### Supplementary Note 8

A method performed by a network node for assisting mobility of a user equipment (UE) between cells of a non-terrestrial network and a terrestrial network, the method comprising:
transmitting first information identifying at least one group of neighbour frequencies, wherein each group of the at least one group corresponds to at least one frequency or cell of the terrestrial network, the information being adapted for use by the UE in scanning frequencies for finding at least one neighbour cell in one group from the at least one group indicated by the first information.

### Supplementary Note 9

The method according to Supplementary Note 8, wherein
the each group includes a respective predetermined area where the neighbour frequencies corresponding to the each group serves, the information being adapted for use by the UE in scanning the frequencies identified by the first information, serving that the respective predetermined area corresponding to the current location of the UE for finding the at least one neighbour cell.

### Supplementary Note 10

A user equipment (UE) configured to perform mobility between cells of a non-terrestrial network and a terrestrial network, the UE comprising:
means for receiving first information identifying at least one group of neighbour frequencies, wherein each group of the at least one group corresponds to at least one frequency or cell of the terrestrial network; and
means for scanning frequencies identified by the first information for finding at least one neighbour cell in one group from the at least one group indicated by the first information.

### Supplementary Note 11

The UE according to Supplementary Note 10, wherein
the each group includes a respective predetermined area where the neighbour frequencies corresponding to the each group serves, and the UE further comprises:
means for determining a current location of the UE, and wherein
the means for scanning is configured to scan the frequencies identified by the first information, serving that the respective predetermined area corresponding to the current location of the UE for finding the at least one neighbour cell.

### Supplementary Note 12

A network node for assisting mobility of a user equipment (UE) between cells of a non-terrestrial network and a terrestrial network, the network node comprising:
means for transmitting first information identifying at least one group of neighbour frequencies, wherein each group of the at least one group corresponds to at least one frequency or cell of the terrestrial network, the information being adapted for use by the UE in scanning frequencies for finding at least one neighbour cell in one group from the at least one group indicated by the first information.

### Supplementary Note 13

The network node according to Supplementary Note 12, wherein
the each group includes a respective predetermined area where the neighbour frequencies corresponding to the each group serves, the information being adapted for use by the UE in scanning the frequencies identified by the first information, serving that the respective predetermined area corresponding to the current location of the UE for finding at least one neighbour cell.

This application is based upon and claims the benefit of priority from Great Britain Patent Application No. 2111338.6, filed on Aug. 5, 2021, the disclosure of which is incorporated herein in its entirety by reference.

### REFERENCE SIGNS LIST

1 mobile (cellular or wireless) telecommunication system
3 mobile device
5 satellite
6 gateway/base station
7 data (or core) network
31 transceiver circuit
33 antenna
35 user interface
36 Universal Subscriber Identity Module (USIM)
37 controller
39 memory
41 operating system
43 communications control module
45 positioning module
51 transceiver circuit
53 antenna
57 controller
59 memory
61 operating system
63 communications control module
71 transceiver circuit
73 antenna
75 network interface
77 controller
79 memory
81 operating system
83 communications control module

What is claimed is:

1-13. (canceled)

14. A method performed by a user equipment (UE) for mobility between cells of a non-terrestrial network and a terrestrial network, the method comprising:
receiving first information identifying mapping of at least one group of neighbour frequencies and at least one coverage area for the terrestrial network where the neighbour frequencies serves; and
scanning neighbour frequencies for finding at least one neighbour cell in the at least one coverage area corresponding to one group of the at least one group indicated by the first information.

15. The method according to claim 14, wherein
the scanning is performed based on a location of the UE.

16. The method according to claim 14, further comprising:
performing a search for finding at least one potential neighbour cell for each group of the at least one group; and
determining the one group, based on a frequency used by the at least one potential neighbour cell and the first information.

17. The method according to claim 14, wherein
the first information is transmitted via a system information block.

18. The method according to claim 14, further comprising:
not scanning any frequency that is not associated with the at least one coverage area that corresponds to a current location of the UE.

19. A method performed by a network node for assisting mobility of a user equipment (UE) between cells of a non-terrestrial network and a terrestrial network, the method comprising:
transmitting first information identifying mapping of at least one group of neighbour frequencies and at least one coverage area for the terrestrial network where the neighbour frequencies serves, the first information being configured for use by the UE in scanning neighbour frequencies for finding at least one neighbour cell in the at least one coverage area corresponding to one group of the at least one group indicated by the first information.

20. A user equipment (UE) configured to perform mobility between cells of a non-terrestrial network and a terrestrial network, the UE comprising:
at least one memory storing instructions; and
at least one processor configured to process the instructions to:
receive first information identifying mapping of at least one group of neighbour frequencies and at least one coverage area for the terrestrial network where the neighbour frequencies serves; and
scan neighbour frequencies for finding at least one neighbour cell in the at least one coverage area corresponding to one group of the at least one group indicated by the first information.

21. A network node for assisting mobility of a user equipment (UE) between cells of a non-terrestrial network and a terrestrial network, the network node comprising:
at least one memory storing instructions; and
at least one processor configured to process the instructions to:
transmit first information identifying mapping of at least one group of neighbour frequencies and at least one coverage area for the terrestrial network where the neighbour frequencies serves, the first information being configured for use by the UE in scanning neighbour frequencies for finding at least one neighbour cell in the at least one coverage area corresponding to one group of the at least one group indicated by the first information.
